(19) United States
(12) Patent Application Publication
(10) Pub. No.: US 2024/0409002 A1
(43) Pub. Date: Dec. 12, 2024

(54) Battery Charging Protocols

(71) Applicant: Jaguar Land Rover Limited, Whitley, Coventry (GB)

(72) Inventor: Atharva SAPTE, Coventry, Warwickshire (GB)

(21) Appl. No.: 18/720,430

(22) PCT Filed: Dec. 12, 2022
(86) PCT No.: PCT/EP2022/085325

§ 371 Date: Jun. 14, 2024

(30) Foreign Application Priority Data
Dec. 14, 2021 (GB) 2118037.7

(51) Int. Cl. B60L 58/13; B60L 53/62; B60L 58/27; H02J 7/00

(52) U.S. Cl. CPC B60L 58/13; B60L 53/62; B60L 58/27; H02J 7/007194; B60L 2240/545; B60L 2260/50

(57) ABSTRACT

A control system (100) for a traction battery (1000) in an electrically powered vehicle. The control system (100) is configured to: receive a journey start time (102) indicative of a time at which the traction battery will be used to power the vehicle; calculate, using the journey start time (102), and in dependence on a target battery charge level (104) and a target battery operating temperature range (106), a charging start time (108) at which to start charging of the traction battery (1000) to: charge the traction battery toward the target battery charge level by the journey start time; and heat the traction battery, due to charging of the traction battery, toward a temperature within the target battery operating temperature range, by the journey start time; and output the determined charging start time (108).

### TECHNICAL FIELD

The present disclosure relates to control systems for batteries and controlling charging of batteries, for example, traction batteries in electrically powered vehicles. Aspects of the invention relate to control systems, systems, and methods for a traction battery in an electrically powered vehicle, computer software, and an electrically powered vehicle.

### BACKGROUND

There has recently been increased interest in providing battery-powered vehicles, which has led to developments in vehicle batteries, in particular vehicle traction battery technology. For optimal efficiency and driving range the battery should operate in a particular temperature range dependent on the type of battery. For example, a Li-ion traction battery may operate most efficiently if the battery cell temperature is between 15° C. and 35° C. Outside the temperature range the battery performance may not be as efficient or healthy for the battery life.

A typical charging protocol for a traction battery of an electrically powered vehicle is for the traction battery to be connected to a charging source (e.g. plugged into the grid) and then charging of the battery takes place once connected for charging. During charging, heat is generated in the battery as a function of the current and resistance of the conductive material and the internal resistance of the cells. The battery may be charged to a nominally full level (e.g. 100%) capacity and charging stops. Between the end of charging, and unplugging the charging connection from the battery, the battery generally cools down by heat transfer to an ambient temperature.

Later, a user wishes to drive the vehicle. Typically, a pre-conditioning signal is received by the vehicle battery to indicate that the vehicle is to be used soon, at which point the battery (and e.g. electric drive units) are typically at an ambient temperature which is below the desired operative battery temperature range. The battery may thus be heated up, for example using a resistive heating device or system, and/or by using a heat pump, to achieve a battery temperature in the temperature range in which that battery runs efficiently. Powering the additional heating device/system requires further energy to be drawn, for example from a charging source (plug/mains). The battery operation (and e.g. propulsion efficiency, and/or battery lifetime) may thus be increased by achieving a battery temperature in the desired range when using the battery to power the vehicle rather than the battery being too cold, but this temperature adjustment incurs the cost of further energy supplied to heat it.

It is an aim of the present invention to address one or more of the disadvantages associated with the prior art.

### SUMMARY OF THE INVENTION

Aspects and embodiments of the invention provide control systems, systems, methods, a vehicle and computer software as claimed in the appended claims.

According to an aspect of the present invention there is provided a control system comprising one or more controllers, the control system configured to: receive a use start time indicative of a time at which a battery will be used; calculate, using the use start time, and in dependence on a target battery charge level and a target battery operating temperature range, a charging start time at which to start charging of the battery to: charge the battery toward the target battery charge level by the use start time; and heat the battery, due to charging of the battery, toward a temperature within the target battery operating temperature range, by the use start time; and output the determined charging start time.

According to an aspect of the present invention there is provided a control system for a traction battery in an electrically powered vehicle, the control system comprising one or more controllers, the control system configured to: receive a journey start time indicative of a time at which the traction battery will be used to power the vehicle; calculate, using the journey start time, and in dependence on a target battery charge level and a target battery operating temperature range, a charging start time at which to start charging of the traction battery to: charge the traction battery toward the target battery charge level by the journey start time; and heat the traction battery, due to charging of the traction battery, toward a temperature within the target battery operating temperature range, by the journey start time; and output the determined charging start time.

By using a journey start time, an expected time of use of the vehicle (battery) is known, and then charging of the battery can be planned to start in advance of this time to ensure the battery is charged. By performing charging, which itself heats the battery, at a time such that battery temperature is in a desired operating temperature range, through heat produced by charging, at the expected time of use, there is a reduced reliance of using an external heater to heat the battery to a desired temperature in time for the battery to be used, and the heat generated through charging is “put to good use” in heating the battery to a desired temperature for use. That is, use is made of the thermal energy generated during charging to pre-condition (i.e. pre-warm) the battery prior to use, so the battery is at an operating temperature providing good battery efficiency and operation at the point of use. The present invention therefore helps avoid losing energy due to the need for external pre-heating of the battery.

Advantageously, a desired (e.g. a maximum, or possibly a maximum achievable in a given timeframe prior to departure) amount of stored energy is available in a battery for performing a journey and the battery is operated at a maximum (or high) efficiency. Also advantageously, the traction battery is able to be simply and safely operated within a desired temperature range (e.g. below 60° C. for example), and/or the battery is enabled to operate with a minimum voltage (e.g. above −25° C.), without or with reduced dependence on an external heater to pre-warm the battery.

The one or more controllers may collectively comprise: at least one electronic processor having an electrical input for receiving the journey start time and an electrical output for providing the determined charging start time; and at least one memory device coupled to the at least one electronic processor and having instructions stored therein; wherein the at least one electronic processor is configured to access the at least one memory device and execute the instructions stored therein so as to calculate, using the journey start time, and in dependence on the target battery charge level and the target battery operating temperature range, the charging start time at which to start charging of the traction battery to both: charge the traction battery toward the target battery charge level by the journey start time; and heat the traction battery, due to charging of the traction battery, to a temperature within the target battery operating temperature range, by the journey start time.

The control system may be configured to output a charge start indication at the determined charging start time to a charger, the charge start indication configured to cause the charger to supply electrical power to a connected battery to charge the traction battery.

The control system may be configured to: in a first charging process phase, starting at a time of connection of the traction battery to a charger, control the supply of charge to the traction battery to charge the traction battery to a first battery charge level less than the target battery charge level; and in a further charging process phase, control the supply of charge to the traction battery to charge the traction battery toward the target battery charge level, wherein the further charging process phase starts at the determined charging start time.

The control system may be configured to: output a suspend indication to a charger connected to a battery to suspend the provision of charge to the traction battery when the traction battery charge reaches the first battery charge level; and output a charging indication to the charger to recommence the provision of charge to the traction battery at determined charging start time to charge the traction battery toward the target battery charge level by the journey start time and heat the traction battery, due to charging of the traction battery, to a temperature within the target battery operating temperature range, by the journey start time.

The control system may be configured to calculate the charging start time in dependence on one or more of: a starting battery charge level prior to charging; a power rating of a charger attached to the traction battery; and a battery temperature prior to charging.

Calculating an amount of charge to be supplied to the traction battery may be performed in dependence on a starting battery charge level prior to charging and the target battery charge level.

Determining the charging start time may be performed in dependence on the calculated amount of charge to be supplied to the traction battery and a power rating of a charger attached to the traction battery.

Calculating the charging start time may comprise: calculating an amount of heat power rejected from the traction battery during charging in dependence on a charging current used to charge the traction battery and a resistance of the traction battery; and determining the charging start time in dependence on the calculated amount of heat power rejected from the traction battery during charging, a required temperature increase to heat the traction battery to within the target battery operating temperature range, a mass of the traction battery, and a specific heat capacity of the traction battery.

The charging current used to charge the traction battery may be determined in dependence on a power rating of the charger attached to the traction battery, and a charging voltage applied to the traction battery. The charging current used to charge the traction battery may be determined in dependence on a charge acceptance of the traction battery.

The control system may be configured to: determine if the traction battery can be heated to a temperature within the target battery operating temperature range, due to charging of the traction battery, by the journey start time, and if the traction battery cannot be heated to a temperature within the target battery operating temperature range due to charging of the traction battery, provide an indication that supplemental heating by a heating device is required to heat the traction battery to a temperature within the target battery operating temperature range by the journey start time.

The journey start time may be received by one or more of: a user providing an indicated journey start time input to the control system; a user providing an indicated journey start time input to a user device remote from and in wireless communication with the control system; determination of the journey start time, by the control system, based on historical battery usage patterns; and determination of the journey start time, by the control system, based on a user scheduled journey recorded in a scheduling application.

The control system may be connected to a transceiver configured to receive the indicated journey start time input, and/or an indication of the user scheduled journey recorded in a scheduling application, from a remote user device.

If the journey start time is determined by the control system, the control system may be configured to provide an indication of the determined journey start time to a user device; and one or more of: receive, from the user device, a user-provided confirmation of the determined journey start time, thereby causing the control system to cause the charger to supply electrical power to a connected battery to charge the traction battery at the determined charging start time; and receive, from the user device, a user-provided rejection of the determined journey start time, thereby preventing the control system from causing the charger to supply electrical power to a connected battery at the determined charging start time.

Determination of the journey start time based on historical battery usage patterns may comprise determination of a predicted journey start time using a machine learning model trained using historical battery usage patterns.

The target battery operating temperature range may be between 15° C. and 35° C.

The target battery charge level may be one or more of: set by a user; a manufacturer default level; or determined in dependence on battery energy requirements of a planned journey planned to start at the journey start time.

According to another aspect of the invention, there is provided a system for a vehicle, comprising a control system is disclosed herein and a traction battery of the vehicle. The traction battery may be a Li-ion cell, and the target battery operating temperature range may be between 15° C. and 35° C.

According to another aspect of the invention, there is provided a vehicle comprising any control system, or system disclosed herein. The vehicle may be a hybrid electric vehicle, or an electric vehicle, for example.

According to another aspect of the invention, there is provided a method of charging a battery of a vehicle, comprising: receiving a journey start time indicative of a time at which the traction battery will be used to supply power to the vehicle; calculating, using the journey start time, and in dependence on a target battery charge level and a target battery operating temperature range, a charging start time at which to start charging of the traction battery to both: charge the traction battery toward the target battery charge level by the journey start time; and heat the traction battery, due to charging of the traction battery, to a temperature within the target battery operating temperature range, by the journey start time; and outputting the determined charging start time to a charger to cause charging of the traction battery at the determined charging start time.

According to another aspect of the invention, there is provided computer software which, when executed, is arranged to perform any method disclosed herein.

According to another aspect of the invention, there is provided a non-transitory, computer-readable storage medium storing instructions thereon that, when executed by one or more electronic processors, causes the one or more electronic processors to carry out any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a control system configured to calculate a charging start time, which may be connected to a traction battery, according to examples disclosed herein;

FIG. 2 shows a control system comprising one or more controllers according to examples disclosed herein;

FIG. 3 shows an example of operation of a control system which is configured to calculate a charging start time in a phased charging process according to examples disclosed herein;

FIG. 4 shows a control system configured to calculate a charging start time in a phased charging process according to examples disclosed herein;

FIG. 5 shows an example of parameters which may be accounted for by the control system in determining the charging start time, according to examples disclosed herein;

FIG. 6 shows a process of determining if a supplemental heater is to be used to heat a traction battery according to examples disclosed herein;

FIG. 7 shows an example method according to examples disclosed herein; and

FIG. 8 shows a vehicle in accordance with examples disclosed herein.

### DETAILED DESCRIPTION

Traction battery charging for an electric vehicle typically takes place by charging the battery to a target charge level, or to a nominally maximum charge level upon connection on the charging source to the traction battery. A target charge level may be used, which may not be a maximum charge level possible. For example, the user may want to help maintain battery health by avoiding “full”/maximum charging. As another example, the user may not want to charge more than is required for a journey ahead, for example if charging is expensive or slow at a particular charging point. During charging, heat is generated in the battery as a function of the current and resistance of the conductive material and the internal resistance of the cells. Once the charge level is reached, charging stops and the generated heat dissipates, thereby thermal energy in the battery is lost to the environment.

Later, when the vehicle is to be used and powered by the battery, it is desirable to have a battery operating temperature within a particular temperature range to obtain improved battery operation (e.g. battery efficiency and lifetime). Operating a battery in a preferred operating temperature range contributes to improved efficiency of battery operation and longer battery life. The cells of a battery operating at temperatures below preferred operating temperature range may exhibit up to 40% reduced efficiency. The causes of reduced efficiency may include the inefficient conversion of chemical energy of the battery into electric energy, and/or may include the internal resistance of the battery being increased so that electrical energy is dissipated within the battery due to its internal resistance. The net result of reduced battery efficiency is that less of the energy stored in the battery is made available to power the vehicle which could mean that the vehicle range capability is reduced. Although these inefficiencies of the battery will generally cause the battery to heat up (‘self-heating’), and so become more efficient, the energy that is converted into heat is not available to power the vehicle. Customers desire to have maximum range capability of their fully charged battery, even if they do not plan to travel on a long journey.

Sometimes fast charging is preferably to be avoided in this temperature range, as it may degrade the battery. Staying in this zone if the battery is inactive (i.e. not being used to power the vehicle) should not pose a material risk of failure or permanent degradation of the battery, however. The cells of a battery operating at temperatures above the preferred operating temperature range may provide sufficient power (e.g. the battery may be considered to operate in a boost mode), and the battery cells may be able to charge at a higher power, due to reduced resistance. However a robust cooling system is required to operate in this temperature range otherwise the battery cells may overheat.

Critically to prevent the cells reaching the “Failure”/“Shut-down” zone at which point they are too hot to operate correctly and may be damaged, it is recommended to de-rate the vehicle/system performance. The higher the operating temperature, the more aggressive the de-rate should be to compensate. Within the preferred operating temperature range, the battery cells can charge and discharge at optimum/high efficiency, and are capable of providing the rated power output. For optimal/high efficiency and driving range, the battery may be heated or cooled to this temperature range.

Typically prior to operation, the battery is at a temperature below the preferred operating temperature range, and an additional heater may be used to pre-heat the battery prior to use, which requires energy input. The battery and propulsion efficiency may thus be increased by achieving a battery temperature in the desired range, but at the cost of further energy supplied to heat it using the additional heater.

Examples disclosed herein recognise that improvements to traction battery charging may be achieved by making use of the thermal energy generated during charging to pre-condition (i.e. pre-warm) the battery prior to use so the battery is at an operating temperature providing good battery efficiency and operation at the point of use. The present invention therefore helps avoid losing energy due to the need for external pre-heating of the battery.

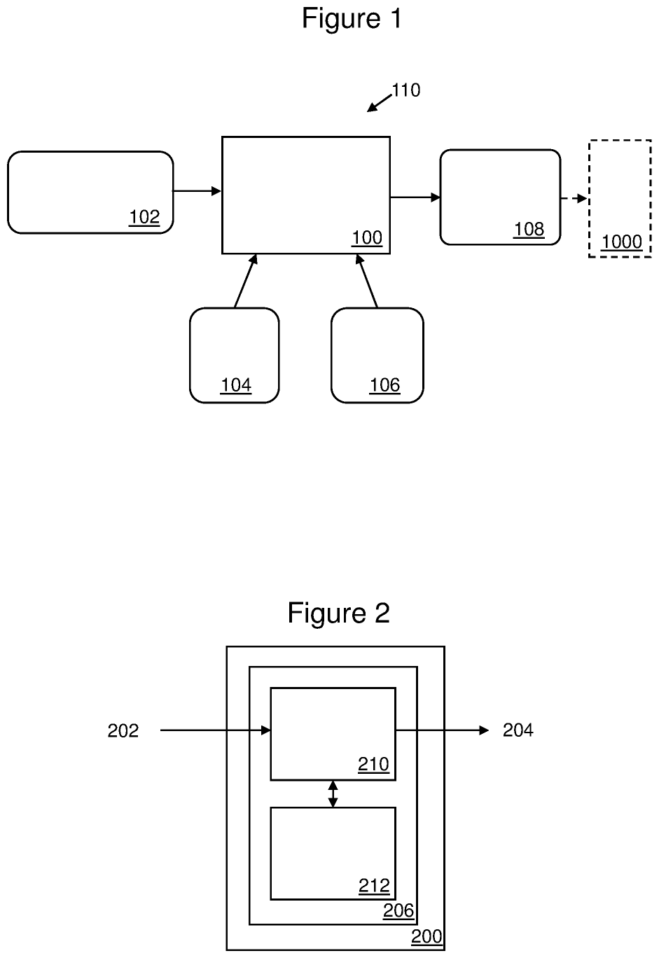

FIG. 1 shows an example of a control system 100 for a traction battery 1000 in an electrically powered vehicle. The traction battery 1000 is a battery configured to provide power to an electric machine (for example, via an inverter) in order to drive/power the vehicle. That is, the battery may be used to provide power to the powertrain of the vehicle to propel the vehicle. The battery may, for example, be a 48V battery, or may be a 400V or 800V battery. Such a battery may be used in a variety of electrically powered vehicles such as a hybrid vehicle (e.g. a plug-in hybrid electric vehicle (PHEV) or a range-extended electric vehicle (REEV)), or in a battery electric vehicle (BEV). The battery may be configured to receive charge from a plug-in charging system and may be capable of receiving/accepting charge from an Alternating Current (AC) and/or a Direct Current (DC) source.

The control system 100 is configured to receive a journey start time 102. The journey start time 102 is indicative of a time at which the traction battery 1000 will be used to power the vehicle. For example, the control system 100 may receive an indication that the vehicle will be used at 7 am the next day. Further discussion on receiving the journey start time is provided later.

The control system 100 is configured to calculate, using the journey start time 102, and in dependence on a target battery charge level 104 and a target battery operating temperature range 106, a charging start time 108. As an example of a target battery charge level 104, the user may wish to charge the battery to 80% full, or 100% full charge. As an example target battery operating temperature range 106, the battery may be most efficiently operated in the temperature range of 15° C. to 35° C. and this temperature range would be the target battery operating temperature range 106. A Li-ion cell battery may be used and may have a target battery operating temperature range between 15° C. and 35° C.

In other examples, some battery technologies enable a wider operating range of battery temperatures of 15° C. to 50° C. Or, in colder climates, specific battery cell chemistry may be employed so the desired operating temperature range may be lower than 15° C. to 35° C. (e.g. from 5° C. to 20° C.). A more general desirable battery temperature operating range may be, for example, of −25° C. (minus 25° C.) to +60° C. (plus 60° C.)—for example, the operating range may be determined according to a “deliver minimum voltage” range which runs from a minimum of −25° C. up to a maximum safe operation temperature of up to +60° C.). In some examples, a lower bound of temperature operating range of −30° C. (minus 30° C.) may be possible (and for example, a maximum operating temperature of +60° C.).

The charging start time 108 is a time at which to start charging of the traction battery 1000 to charge the traction battery 1000 toward the target battery charge level by the journey start time 102. The charging start time 108 is also a time at which to start charging of the traction battery 1000 to heat the traction battery, due to charging of the traction battery, toward a temperature within the target battery operating temperature range 106, by the journey start time 102. By the term “toward the target battery charge level”, it is intended to mean that the battery may be charged so the charge level in the battery is increased to be closer to the target battery charge level. In some cases the target may be reached (i.e. the target is 80% charge, and at the journey start time, the battery charge is indeed 80%) which is desirable. In some cases the target may not be reached (for example, due to an unpredictable factor affecting the charging process, such as unexpected cold weather causing slower charging than expected, battery fatigue/aging not accounted for, or an unexpected short journey taken between determining the charging start time and actually supplying charge to the battery to reach the target charge level) a target battery charge level may be 80% but the charge level reached by the journey start time may be increased towards the target battery charge level, to e.g. 75% or 78% from e.g. 30% or 10%. While the target charge level is not quite met in such examples, a good or best attempt to achieve the target charge level can still be made.

The control system 100 is configured to output the determined charging start time 108. For example, the charging start time 108 may be provided to a further charger controller which is configured to start or stop the provision of charge from a charger to the battery 1000 based on the charging start time 108. As another example, the charging start time 108 may be provided to the charger to which the battery 1000 is connected and the charger may use the provided charging start time 108 to control when charge is provided to the battery 1000. As a further example, the charging start time 108 may be provided to a user device, such as a smartphone or home hub, to indicate e.g. when the battery will be charged, is charging, and/or is connected but not being charged, or to remotely monitor and/or control the charger.

In this way, at the start time of use of the battery 102, the control system 100 can provide control of the battery charging process so that the battery can be charged to, or at least towards, the desired starting charge level 104, and the battery will have a temperature within the target battery operating temperature range 106. Timing the start of charging in this way allows for a reduction on the reliance on an external heater to pre-warm the battery prior to use so that the battery is operated in the desired “healthy” battery temperature range. In some examples timing the start of charging in this way allows for an elimination of the reliance on an external heater to pre-warm the battery prior to use. Such examples may also reduce the energy required to operate the vehicle, because the residual heat generated in the charging process is used to pre-warm the battery to the desired operating temperature.

Thus, the battery 1000 may not necessarily start to charge immediately after being plugged in to a charger. Battery charging may be delayed to allow the battery to charge to required energy level, while also allowing the internal resistance of the pack and cells to heat the conductive material and cells, thereby increasing the battery efficiency (by warming it to a desired efficient operating temperature) without requiring (at least as much) energy from the charge source to operate a separate heater. As a result the battery is preconditioned, or at least partially preconditioned, to operate in a healthy battery temperature range while using less energy than if a resistive heater alone was used to pre-warm the battery. Battery preconditioning (e.g. changing the temperature of the vehicle battery to within a desired operating temperature range) may be considered separately from vehicle preconditioning. Vehicle preconditioning may be considered to be preparing the vehicle cabin to provide a desired climate or environment in time for a user to occupy the vehicle—for example, the cabin air temperature may be pre-heated or pre-cooled, a vehicle seat or heated steering wheel may be pre-warmed, and/or windows may be pre-warmed to de-fog or defrost them, in time for a user to occupy the vehicle and drive without waiting.

The control system 100 may be configured to output a charge start indication at the determined charging start time to a charger. The charger may be, for example, an On-Board Charger (OBC), or may be an off-board charger. An On-Board Charger may convert AC mains electrical power to DC electrical power for the battery, because the battery is a DC component. An Off-Board Charger may provide DC electrical power directly (i.e. without AC/DC conversion) straight to the battery. Control systems 100 disclosed herein may be able to operate to control either, or both, such types of charger. The charge start indication may be configured to cause the charger to supply electrical power to a connected battery to charge the traction battery. That is, the control system 100 may not only determine a time at which to start charging the battery, but may provide a control signal to operate the charger to which the battery is connected to cause the charger to supply charge to the battery at the calculated charging start time.

The combination of a control system 100 as disclosed herein and a traction battery 1000 of a vehicle may be considered to be a system 110 for a vehicle. The traction battery 1000 may, for example, deliver a voltage with Direct Current (DC). A charging system charging the battery under the control of the control system 100 may able to connect to the battery and provide charge as an Alternating Current source, for example up to 23 kW, or provide charge as a Direct Current source, for example up to 450 kW. Future charging technologies may offer higher charging powers, e.g. AC higher than 23 kW, and/or DC higher than 450 kW.

More generally, FIG. 1 may be considered to represent a control system 100 configured to: receive a use start time 102 indicative of a time at which a battery 1000 will be used; calculate, using the use start time 102, and in dependence on a target battery charge level 104 and a target battery operating temperature range 106, a charging start time 108 at which to start charging of the battery 1000 to: charge the battery toward the target battery charge level 104 by the use start time; and heat the battery, due to charging of the battery, toward a temperature within the target battery operating temperature range 106, by the use start time; and output the determined charging start time 108. That is, examples disclosed herein may be applied to other battery types which may advantageously be pre-warmed by heat generated through charging of the battery to within a desired operating temperature range, just in time for when the battery is to be used to reduce dependence on an external heater to pre-warm a battery for use in a desired temperature range.

FIG. 2 shows an example control system 200 comprising one or more controllers 206 (in this example only one is shown). The one or more controllers 206 collectively comprise: at least one electronic processor 210 having an electrical input 202 for receiving or more input signal(s) (i.e. the journey start time 102, target battery charge level 104, and/or target battery operating temperature range 106) and an electrical output 204 for providing output signal(s) (i.e. the determined charging start time 108); and at least one memory device 212 coupled to the at least one electronic processor 210 and having instructions stored therein. The at least one electronic processor 210 is configured to access the at least one memory device 212 and execute the instructions stored therein so as to calculate, using the journey start time 102, and in dependence on the target battery charge level 104 and the target battery operating temperature range 106, the charging start time 108 at which to start charging of the traction battery 1000 to both: charge the traction battery 1000 toward the target battery charge level by the journey start time 102; and heat the traction battery 1000, due to charging of the traction battery, to a temperature within the target battery operating temperature range 106, by the journey start time 102.

Each controller 206 can comprise a control unit or computational device having one or more suitable electronic processor electronic processors 210 (e.g., a microprocessor, a microcontroller, an application specific integrated circuit (ASIC), Boolean logic circuitry, etc.), and may comprise a single control unit or computational device, or alternatively different functions of the or each controller 206 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of (electronic) instructions may be provided which, when executed, cause the controller 206 to implement the control techniques described herein (including some or all of the functionality required for the method described herein). The set of instructions could be embedded in said one or more electronic processors 210 of the controller 206; or alternatively, the set of instructions could be provided as software to be executed in the controller 206. A first controller or control unit may be implemented in software run on one or more processors. One or more other controllers or control units may be implemented in software run on one or more processors, optionally the same one or more processors as the first controller or control unit. Other arrangements are also useful.

The, or each, electronic memory device 212 may comprise any suitable memory device and may store a variety of data, information, threshold value(s), lookup tables or other data structures, and/or instructions therein or thereon. In an embodiment, the memory device 212 has information and instructions for software, firmware, programs, algorithms, scripts, applications, etc. stored therein or thereon that may govern all or part of the methodology described herein. The processor, or each, electronic processor 210 may access the memory device 212 and execute and/or use that or those instructions and information to carry out or perform some or all of the functionality and methodology describe herein.

The at least one memory device 212 may comprise a computer-readable storage medium (e.g. a non-transitory, non-volatile or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM and EEPROM); flash memory; or electrical or other types of medium for storing such information/instructions.

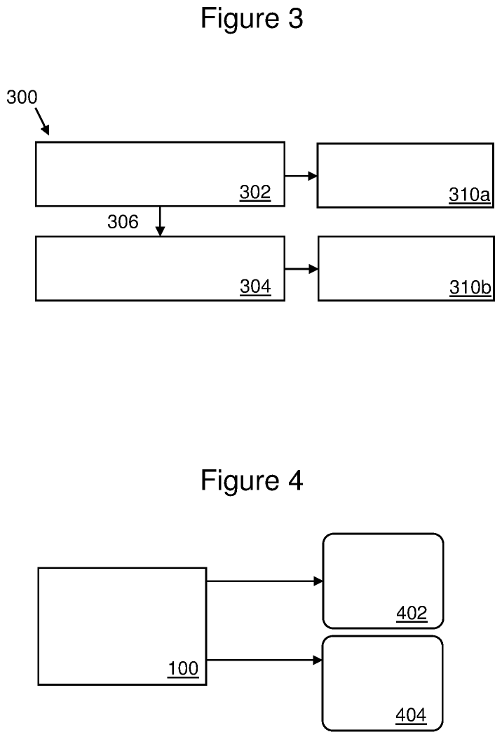

FIG. 3 shows an example of operation 300 of a control system 100 which is configured to calculate a charging start time in a phased charging process. For example, it may be possible to provide a first portion of the charging energy upon connection of the charger to the battery, and provide the remaining charging energy to increase the battery charge level starting at a later time to achieve the target battery charge level 104 and the battery operating temperature within the target range 106 at the journey start time 102. In an example the first portion may be 50% of a target total charge level of 80% and the remaining charging energy may be 30%, to meet the target of 80%. Thus there may be a delay 306 between a first charging phase 302 and a further charging phase 304.

In this way, the vehicle is provided with some charge due to the provision of some charge upon charger connection to the battery, for example in case the user wants to use the vehicle for an unplanned or impromptu journey. An unplanned or impromptu journey would be a journey taking place before the journey indicated to start by the provided journey start time 102), such as leaving home during the night to travel to a family emergency. For example, a user may start a journey each weekday at 7 am to commute to work and so 7 am Monday to Friday are journey start times 102 which are provided as input to the control system 100. However, if the user needs to make another unplanned journey the vehicle would be at least partially charged, from the charging phase 302 taking place upon connection of the charger to the battery, so that the vehicle is useable. In such unplanned examples, a peripheral heater may be present and used to pre-warm the battery if required, although the control system 100 may still operate according to the provided (“planned”) journey start times as described above to provide the battery pre-warming using charging-generated heat.

FIG. 3 shows that the control system may be configured to, in a first charging process phase 302, starting at a time of connection of the traction battery 1000 to a charger, control the supply of charge to the traction battery to charge the traction battery to a first battery charge 310a level less than the target battery charge level. The control system may also be configured to then, in a further charging process phase 304, control the supply of charge to the traction battery 1000 to charge the traction battery toward the target battery charge level 310b, wherein the further charging process phase starts at the determined charging start time. FIG. 3 shows a two-phase process but in other examples there may be further phases such as three or more.

The control system operating as indicated in FIG. 3 may be configured to control the operation of the charger connected to the traction battery. An example is shown in FIG. 4, in which the control system 100 is configured to output a suspend indication 402 to a charger connected to a battery to suspend the provision of charge to the traction battery when the traction battery charge reaches the first battery charge level 310a (e.g. following a first charging phase 302 commencing upon connection of the charger to the battery). The control system 100 is also configured to output a charging indication 404 to the charger to recommence the provision of charge to the traction battery at determined charging start time (i.e. to begin the further charging phase 304), to charge the traction battery toward the target battery charge level 310b by the journey start time and heat the traction battery, due to charging of the traction battery, to a temperature within the target battery operating temperature range, by the journey start time.

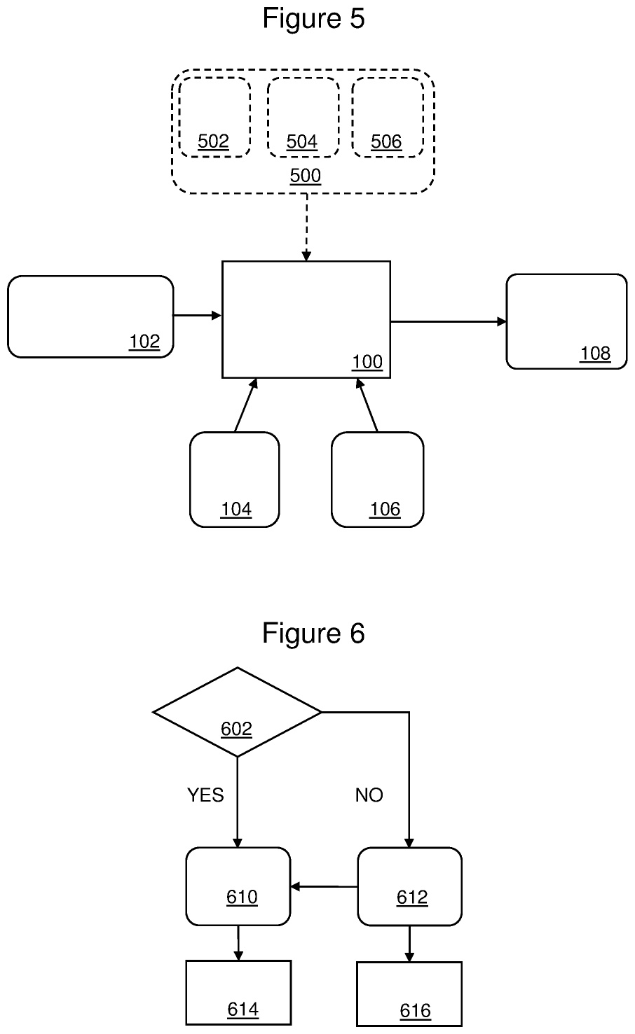

FIG. 5 builds on the example of FIG. 1, wherein the control system 100 is configured to account for one or more further parameters 500 in determining the charging start time 108. The control system 100 of FIG. 5 is configured to calculate the charging start time 108 in dependence on one or more of: a starting battery charge level prior to charging 502; a power rating of a charger attached to the traction battery 504; and a battery temperature prior to charging 506. Thus in some examples, calculating an amount of charge to be supplied to the traction battery may be performed in dependence on a starting battery charge level prior to charging and the target battery charge level. In some examples, determining the charging start time may be performed in dependence on the calculated amount of charge to be supplied to the traction battery and a power rating of a charger attached to the traction battery.

In some examples, the control system may be able to account for the particular climate in which the vehicle is located. For example, if the outdoor temperature is high (e.g. about 30° C.) then the control system may take this into account and cause the battery to charge to rely less on self-heating effects through charging than if the outdoor temperature is lower (e.g. 15° C.), for example, by charging for a large proportion of the required charge level upon charger connection to the battery, and providing a small remaining proportion of charge to top up the battery charge to the desired level just before the journey start time. As another example of accounting for climate, in a hot climate, if the temperature is generally cooler at night (e.g. 10° C.) but is high in the daytime (e.g. 35° C.), the control system may determine to provide most of the required battery charge at night to mitigate against overheating the battery if the journey start time is at a hot time of day (e.g. 2 pm). Conversely, the control system may, instead or as well, if the outdoor temperature is low (e.g. about −8° C.) take this climate into account and cause the battery to charge to rely more on self-heating effects, and possibly also on heat supplied by a supplementary heater, through charging than if the outdoor temperature is higher (e.g. 15° C.))—for example, by providing a large amount of charge to the battery just prior to the journey start time. In some examples, the control system may be able to retrieve an expected ambient temperature at the journey start time (e.g. from a weather report) and determine the charging start time in dependence on the expected temperature at the charging start time. For example, if there is a journey start time in three days' time during which there is predicted to be a heatwave, the expected higher ambient temperature compared to the present temperature may be accounted for in determining the charging start time so the battery temperature is not too high at the journey start time. In this example a battery temperature may be judged too high if it is towards the upper end of the acceptable temperate range or above the upper acceptable temperature bound.

In examples where the power rating of the charger is accounted for, the actual charging power (in e.g. kW) may be dependent on the state of charge of the battery too. For example, a battery which is almost fully charged may take longer to receive a further 5% charge than a battery which is almost fully discharged. In such examples, the self-heating effect, and therefore the charging start time, will depend on the charging characteristics of the battery. The charging characteristics will be fixed for any given battery design and may be determined by battery chemistry for the most part, but they may also vary with the temperature of the battery and/or, in some examples, other battery characteristics such as battery age or historical battery charging activity. This characteristic of having variable charge reception capability of the battery is called the ‘charge acceptance’ of the battery—i.e. the instantaneous capability of the battery to accept charge. Example control systems of this disclosure may take the state of charge of the battery (i.e. the charge acceptance) into account when determining the charging start time.

In some examples, the control system 100 may take account of heat power lost due to charging when determining the charging start time 108. That is, the control system 100 may calculate the charging start time 108 by calculating an amount of heat power rejected from the traction battery during charging. The amount of heat power rejected may be determined in dependence on a charging current used to charge the traction battery and a resistance of the traction battery. The control system 100 may then determine the charging start time in dependence on the calculated amount of heat power rejected from the traction battery during charging. The control system may also take into account other factors, such as a required temperature increase to heat the traction battery to within the target battery operating temperature range, a mass of the traction battery, and a specific heat capacity of the traction battery. In some examples, the charging current used to charge the traction battery may be determined in dependence on a power rating of the charger attached to the traction battery, and a charging voltage applied to the traction battery (and in some cases, the charge acceptance of the battery as discussed above). In other examples, the control system may not necessarily consider heat power rejected during charging, and simply determine the charging start time 108 based on a duration of charging (e.g. as the energy required to be added divided by the power of the charger) and the journey start time 102. This would also provide an estimate of the battery heating.

In some cases, the heat generated during charging may be sufficient to achieve a desired battery operating temperature within the target battery operating temperature range at the journey start time. In some cases, however, the self-heating achieved due to charging may still not be sufficient to achieve a battery operating temperature within the target battery operating temperature range. To accommodate such cases, as illustrated in FIG. 6, the control system 100 may be configured to determine 602 if the traction battery can be heated to a temperature within the target battery operating temperature range, due to charging of the traction battery, by the journey start time. That is, the control system may determine if enough heat can be supplied 602 through charging. If the traction battery cannot be heated to a temperature within the target battery operating temperature range due to charging of the traction battery, the control system 100 may provide an indication 612 that supplemental heating by a heating device is required to assist heating the traction battery to a temperature within the target battery operating temperature range by the journey start time. The control system 100 may provide a control signal to the supplemental heater 616 to control the operation of the supplemental heater to provide the required supplemental heat, in combination with providing a signal to the charger 614 to commence charging at the determined charging time 610 to achieve the required battery operating temperature at the journey start time, in some examples. If however, the traction battery can be heated to a temperature within the target battery operating temperature range due to charging of the traction battery, then no supplemental heating is required.

In the above examples, the control system 100 receives a journey start time 102 indicating the time at which the vehicle is going to be used. This journey start time 102 may be provided in various ways. For example, a user may provide an indicated journey start time 102 input to the control system 100 by a keyboard or other input device, such as “Friday leaving at 8 am, drive to Heathrow Airport”. As another example, a user may provide an indicated journey start time input to a user device remote from and in wireless communication with the control system. For example, rather than inputting a journey to the control system or a peripheral of the control system, the user may input a journey start time to a smartphone which can communicate wirelessly with the control system e.g. via an application program (“app”).

In other examples the journey start time need not necessarily be provided by a user directly. For example, the control system may be configured to determine the journey start time based on historical battery usage patterns. That is, the control system may be able to access historical records of when the vehicle has been used, and from these records, estimate a future time at which the vehicle will be in use. For example, if a user usually uses the vehicle between 8 am and 9 am on a Saturday, then the control system may charge the battery so that it is ready for a future journey at 8 am on a following Saturday. Determination of a predicted journey start time by the control system may comprise using a machine learning model trained using historical battery usage patterns to predict future battery usage requirements. In a further example, the control system may be configured to determine the journey start time based on a user scheduled journey recorded in a scheduling application. For example, if a user had recorded an event in a calendar of “holiday in Anglesey—arrive at destination for 12 noon 1 August” then the control system may be able to determine that the journey time on that day and time is expected to be 3 hours from the users home location (this prediction itself may be based on historical traffic data accessible by the control system) and set the charging start time so the battery is charged to the target battery charge level and within the desired operating temperature range for 3 hours prior to 12 noon on 1 August (i.e. 9 am that day which is the journey start time). Communication with the control system from a remote device may be made via a transceiver connected to the control system, the transceiver being configured to receive the indicated journey start time input, and/or an indication of the user scheduled journey recorded in a scheduling application, from a remote user device.

If the journey start time is determined by the control system 100, the control system 100 may be configured to provide an indication of the determined journey start time to a user device (e.g. as a push alert, SMS or email, for example). The control system 100 may also be configured in some examples to receive, from the user device, a user-provided confirmation of the determined journey start time. Such user confirmation may thereby cause the control system to cause the charger to supply electrical power to a connected battery to charge the traction battery at the determined charging start time. The control system 100 may also be configured in some examples to receive, from the user device, a user-provided rejection of the determined journey start time, thereby preventing the control system from causing the charger to supply electrical power to a connected battery at the determined charging start time. In this way, a manual check of a machine-predicted battery usage may be provided to help prevent unnecessary charging and heating if the predicted journey is not actually going to take place.

In some examples, the target battery charge level may be set by a user (for example, a user may wish to fully charge the battery, i.e. to 100% charge, or the user may wish to charge the battery mostly full, e.g. to 80% of 90% of full charge. In some examples, the target battery charge level may be a manufacturer default level (e.g. 100%, or possibly lower, e.g. for battery life protection and/or pricing reasons). In some examples, the target battery charge level may be determined in dependence on battery energy requirements of a planned journey planned to start at the journey start time. For example, a user may plan a route from location A to location B. The control system may determine (or may receive, from an external apparatus, a determination of) what stored battery charge is required to reach location B from location A, or to reach a charging point between locations A and B. This determination may be made by considering route profile data (e.g. elevation, road surface type, and/or other route parameter which may affect battery charge usage). The system may determine a battery charge of 80% is sufficient to reach the destination/charging point with 10% remaining (or some other required end-of-journey remaining charge level) and so set the traction battery charge level to 80%.

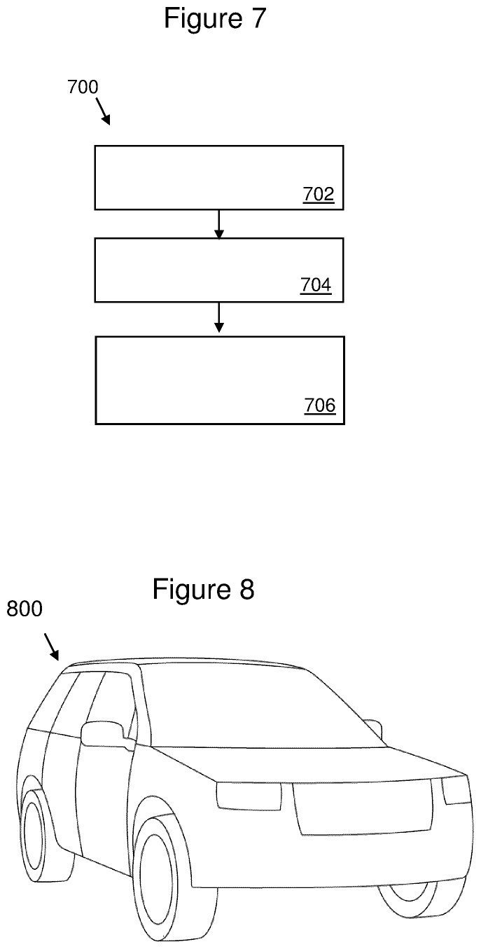

FIG. 7 illustrates an example method 700 of charging a battery of a vehicle. The method 700 comprise receiving a journey start time 702. The journey start time is indicative of a time at which the traction battery will be used to supply power to the vehicle. The method 700 comprises calculating, using the journey start time, and in dependence on a target battery charge level and a target battery operating temperature range, a charging start time at which to start charging of the traction battery 704. The charging start time is calculated to both: charge the traction battery toward the target battery charge level by the journey start time; and heat the traction battery, due to charging of the traction battery, to a temperature within the target battery operating temperature range, by the journey start time. The method 700 comprises outputting the determined charging start time to a charger 706. The output is to cause charging of the traction battery at the determined charging start time, for example directly by operating the charging supply, or by providing an indication of the start time to a further apparatus which controls the charging supply.

FIG. 8 shows a vehicle 800 in accordance with examples disclosed herein.

The following worked examples illustrate scenarios in which the example control systems disclosed here can be used. An example fully insulated battery may have the following specification:

| | |
|---|---|
| Useable capacity (kWh) | 100 |
| Nominal Voltage (V) | 396 |
| Mass m (kg) | 590 |
| Pack specific heat capacity c (kJ/Kg · K) | 1.15 |

Four example scenario calculations are set out as follows:

### Scenario 1

Battery characteristics: 400V, 100 kWh, 0.1 ohm Pack resistance at 20° C. soak, 590 kg (thermal mass)
1. User plugs in vehicle with 50 kWh to 150 kW charger (120 kW average)
2. User has set up a target battery charge level to 80% (80 kWh)
3. A departure time is recognised as 30 mins after plug in

### Charging Protocol:

1. Control system determines charge duration required for adding 30 kWh energy into battery pack
   i. E.g. 30 kWh/120 kW=˜15 mins
2. Battery commences charging 15 mins before departure (i.e. charging starts at 15 mins after plugging in)
3. Battery charges +30 kWh at 300 A
4. Battery heats up in proportion to the Current Q=I²×R (Heat power=Current squared multiplied by Resistance) i.e. 8190 W heat power
5. This heat power, rejected over 15 mins, can heat up the thermal mass of the battery by around 11° C.
6. This temperature increase raises the pack efficiency by 0.6%
7. To achieve the same effect, a resistive heater would require around 7 kWh of additional energy from the plug.

### Scenario 2

Battery characteristics: 400V, 100 kWh, 0.24 ohm Pack resistance at −10° C. soak, 590 kg (thermal mass)
1. User plugs in vehicle with 50 kWh to 11 kW charger (10 kW average)
2. User has set up a target battery charge level of 80% (80 kWh)
3. A departure time is recognised as 07:00 am

### Charging Protocol:

1. Vehicle computer determines charge duration required for adding 30 kWh energy into battery pack
   i. E.g. 30 kWh/10 kW=˜3 hours
2. Vehicle commences charging 3 hours before departure (charging starts at 04:00)
3. Battery charges +30 kWh at 25 A
4. Battery heats up in proportion to the Current Q=I²×R i.e. 150 W heat power
5. This heat power, rejected over 3 hours can heat up the thermal mass of the battery by around 2° C.
6. This temperature increase raises the pack efficiency by 1.1%
7. To achieve the same effect, a resistive heater would require around 2 kWh of additional energy from the plug.

### Scenario 3

Battery characteristics: 400V, 100 kWh, 0.24 ohm Pack resistance at −10° C. soak, 590 kg (thermal mass)
1. User plugs in vehicle with 50 kWh to 11 kW charger (10 kW average)
2. User has not set up a preferred target battery charge level charge, so a manufacturer default of 100% usable capacity is set as the a target battery charge level.
3. A departure time is recognised as 07:00 am

### Charging Protocol:

1. Vehicle computer determines charge duration required for adding 50 kWh energy into battery pack
   i. E.g. 50 kWh/10 kW=˜5 hours
2. Vehicle commences charging 5 hours before departure (charging starts at 02:00)
3. Battery charges +50 kWh at 25 A
4. Battery heats up in proportion to the Current Q=I²×R i.e. 150 W heat power
5. This heat power, rejected over 5 hours can heat up the thermal mass of the battery by around 4° C.
6. This temperature increase raises the pack efficiency by 1.6%
7. To achieve the same effect, a resistive heater would require around 3 kWh of additional energy from the plug.

### Scenario 4

Battery characteristics: 400V, 100 kWh, 0.3 ohm Pack resistance at −10° C. soak, 590 kg (thermal mass)
1. User plugs in vehicle with 10 kWh to 11 kW charger (10 kW average)
2. User has not set up a preferred target battery charge level charge, so a manufacturer default of 100% usable capacity is set as the a target battery charge level.
3. A departure time is recognised as 07:00 am

### Charging Protocol:

1. Vehicle computer determines charge duration required for adding 80 kWh energy into battery pack
   i. E.g. 90 kWh/10 kW=˜9 hours
2. Vehicle commences charging 9 hours before departure (charging starts at 22:00 previous night)
3. Battery charges +90 kWh at 25 A
4. Battery heats up in proportion to the Current Q=I²×R i.e. 190 W heat power
5. This heat power, rejected over 9 hours can heat up the thermal mass of the battery by around 9° C.
6. This temperature increase raises the pack efficiency by 4.7%
7. To achieve the same effect, a resistive heater would require around 6 kWh of additional energy from the plug.

The calculations used to determine the values in the above scenarios are set out below:

| | 1 | 2 | 3 | 4 |
|---|---|---|---|---|
| | Mid Journey, | Domestic, | Domestic, | Domestic, Max |
| Scenario | fast charging | limited charging | typical charging | charging |
| Starting charge remaining (kWh) | 50 | 50 | 50 | 10 |
| Target end charge (kWh) | 80 | 80 | 100 | 100 |
| Charge added (kWh) ΔE | 30 | 30 | 50 | 90 |
| Charger rated power (kW) | 150 | 11 | 11 | 11 |
| Charger effective average power | 120 | 10 | 10 | 10 |
| (kW) P | | | | |
| Charging duration (hh:mm) | 00:15 | 3:00 | 5:00 | 9:00 |
| Charging duration (s) | 900 | 10800 | 18000 | 32400 |
| t = (ΔE/P) × 3600 | | | | |
| Battery temperature at charging | 20 | −10 | −10 | −10 |
| start (° C.) | | | | |
| Charging voltage (V) V | 400 | 400 | 400 | 400 |
| Charging current (A) I = P/V | 300 | 25 | 25 | 25 |
| Average pack resistance throughout | 0.091 | 0.241 | 0.240 | 0.302 |
| charging (ohm) R | | | | |
| Heat power rejected (KW) Q = I² × R | 8.190 | 0.151 | 0.150 | 0.189 |
| Battery temperature increase (° C.) | 11 | 2 | 4 | 9 |
| ΔT = (Q/mc) · t | | | | |
| Battery temperature at charging end | 31 | −8 | −6 | −1 |
| (° C.) | | | | |
| Example battery efficiency for 50 kW | 97 | 89.8 | 89.8 | 90.2 |
| discharge rate at start temperature | | | | |
| (%) | | | | |
| Example battery efficiency for 50 kW | 97.6 | 90.9 | 91.4 | 94.9 |
| discharge rate at end temperature | | | | |
| (%) | | | | |
| Battery efficiency gain for 50 kW | .6 | 1.1 | 1.6 | 4.7 |
| discharge(%) | | | | |
| Additional useable capacity | .6 | 1.1 | 1.6 | 4.7 |
| unlocked for driving (kWh) | | | | |
| Energy saved with new protocol, | 7.4 | 1.6 | 2.7 | 6.1 |
| currently used for additional | | | | |
| resistive heating (kWh) | | | | |

The following relations are used as noted in the table above to help calculate the charging start time:

$$t = \frac{Δ E}{P} \times 3600 \qquad Equation 1$$

$$Q = {I}^{2} R \qquad Equation 2$$

$$I = \frac{P}{V} \qquad Equation 3$$

$$Δ T = \frac{Q}{mc} \times t \qquad Equation 4$$

### Where:

m=Battery Pack Mass
c=Specific Heat Capacity
P=Charging power
ΔE=Energy Added
t=Charging duration
V=Charging Voltage
I=Charging Current
R=Battery pack Resistance
Q=Heat Generated during charging
ΔT=Temperature increase

Also disclosed herein is computer software which, when executed, is arranged to perform any method disclosed herein. The computer software may be stored on a non-transitory computer-readable medium storing instructions thereon that, when executed by one or more electronic processors, causes the one or more electronic processors to carry out any method disclosed herein.

FIG. 8 shows a schematic of a vehicle comprising a control system as described herein. The vehicle may comprise any system described here (e.g. a control system and traction battery, control system and transceiver for wireless communication, a control system, traction battery, and transceiver).

It will be appreciated that various changes and modifications can be made to the present invention without departing from the scope of the present application.

1. A control system for a traction battery in an electrically powered vehicle, the control system comprising one or more controllers, the control system configured to:
receive a journey start time indicative of a time at which the traction battery will be used to power the vehicle;
calculate, using the journey start time, and in dependence on a target battery charge level and a target battery operating temperature range, a charging start time at which to start charging of the traction battery to:
charge the traction battery toward the target battery charge level by the journey start time; and
heat the traction battery, due to charging of the traction battery, toward a temperature within the target battery operating temperature range, by the journey start time; and
output the determined charging start time.

2. The control system of claim 1, wherein the control system is configured to output a charge start indication at the determined charging start time to a charger, the charge start indication configured to cause the charger to supply electrical power to a connected battery to charge the traction battery.

3. The control system of claim 1, wherein the control system is configured to:
in a first charging process phase, starting at a time of connection of the traction battery to a charger, control the supply of charge to the traction battery to charge the traction battery to a first battery charge level less than the target battery charge level; and
in a further charging process phase, control the supply of charge to the traction battery to charge the traction battery toward the target battery charge level, wherein the further charging process phase starts at the determined charging start time

4. The control system of claim 3, wherein the control system is configured to:
output a suspend indication to a charger connected to a battery to suspend the provision of charge to the traction battery when the traction battery charge reaches the first battery charge level; and
output a charging indication to the charger to recommence the provision of charge to the traction battery at determined charging start time to charge the traction battery toward the target battery charge level by the journey start time and heat the traction battery, due to charging of the traction battery, to a temperature within the target battery operating temperature range, by the journey start time.

5. The control system of claim 1, wherein the control system is configured to calculate the charging start time in dependence on one or more of:
a starting battery charge level prior to charging;
a power rating of a charger attached to the traction battery; and
a battery temperature prior to charging.

6. The control system of claim 1, wherein calculating the charging start time comprises:
calculating an amount of heat power rejected from the traction battery during charging in dependence on a charging current used to charge the traction battery and a resistance of the traction battery; and
determining the charging start time in dependence on the calculated amount of heat power rejected from the traction battery during charging, a required temperature increase to heat the traction battery to within the target battery operating temperature range, a mass of the traction battery, and a specific heat capacity of the traction battery.

7. The control system of claim 6, wherein the charging current used to charge the traction battery is determined in dependence on a power rating of the charger attached to the traction battery, and a charging voltage applied to the traction battery.

8. The control system of claim 1, wherein the control system is configured to:
determine if the traction battery can be heated to a temperature within the target battery operating temperature range, due to charging of the traction battery, by the journey start time, and
when the traction battery cannot be heated to a temperature within the target battery operating temperature range due to charging of the traction battery, provide an indication that supplemental heating by a heating device is required to heat the traction battery to a temperature within the target battery operating temperature range by the journey start time.

9. The control system of claim 1, wherein the journey start time is received by one or more of:
a user providing an indicated journey start time input to the control system;
a user providing an indicated journey start time input to a user device remote from and in wireless communication with the control system;
determination of the journey start time, by the control system, based on historical battery usage patterns; and
determination of the journey start time, by the control system, based on a user scheduled journey recorded in a scheduling application.

10. The control system of claim 9 wherein, when the journey start time is determined by the control system, the control system is configured to:
provide an indication of the determined journey start time to a user device; and one or more of:
receive, from the user device, a user-provided confirmation of the determined journey start time, thereby causing the control system to cause the charger to supply electrical power to a connected battery to charge the traction battery at the determined charging start time; and
receive, from the user device, a user-provided rejection of the determined journey start time, thereby preventing the control system from causing the charger to supply electrical power to a connected battery at the determined charging start time.

11. The control system of claim 9, wherein determination of the journey start time based on historical battery usage patterns, by the control system, comprises determination of a predicted journey start time using a machine learning model trained using historical battery usage patterns.

12. The control system of claim 1, wherein the target battery charge level is one or more of:
set by a user;
a manufacturer default level; or
determined in dependence on battery energy requirements of a planned journey planned to start at the journey start time.

13. (canceled)

14. A vehicle comprising a traction battery and a control system for the traction battery, the control system comprising one or more controllers, the control system configured to:
receive a journey start time indicative of a time at which the traction battery will be used to power the vehicle;
calculate, using the journey start time, and in dependence on a target battery charge level and a target battery operating temperature range, a charging start time at which to start charging of the traction battery to:
charge the traction battery toward the target battery charge level by the journey start time; and
heat the traction battery, due to charging of the traction battery, toward a temperature within the target battery operating temperature range, by the journey start time; and
output the determined charging start time.

15. A method of charging a battery of a vehicle, comprising:
receiving a journey start time indicative of a time at which the traction battery will be used to supply power to the vehicle;
calculating, using the journey start time, and in dependence on a target battery charge level and a target battery operating temperature range, a charging start time at which to start charging of the traction battery to both:
charge the traction battery toward the target battery charge level by the journey start time; and
heat the traction battery, due to charging of the traction battery, to a temperature within the target battery operating temperature range, by the journey start time; and
outputting the determined charging start time to a charger to cause charging of the traction battery at the determined charging start time.

16. The method of claim 15, further comprising outputting a charge start indication at the determined charging start time to a charger, the charge start indication configured to cause the charger to supply electrical power to a connected battery to charge the traction battery.

17. The method of claim 15, further comprising:
in a first charging process phase, starting at a time of connection of the traction battery to a charger, controlling the supply of charge to the traction battery to charge the traction battery to a first battery charge level less than the target battery charge level; and
in a further charging process phase, controlling the supply of charge to the traction battery to charge the traction battery toward the target battery charge level, wherein the further charging process phase starts at the determined charging start time

18. The method of claim 17, further comprising:
outputting a suspend indication to a charger connected to a battery to suspend the provision of charge to the traction battery when the traction battery charge reaches the first battery charge level; and
outputting a charging indication to the charger to recommence the provision of charge to the traction battery at determined charging start time to charge the traction battery toward the target battery charge level by the journey start time and heat the traction battery, due to charging of the traction battery, to a temperature within the target battery operating temperature range, by the journey start time.
